(19) United States
(12) Patent Application Publication
(10) Pub. No.: US 2016/0240096 A1
(43) Pub. Date: Aug. 18, 2016

(54) MOTION DEVICE

(71) Applicant: SYNFLYT PTY LTD, New South Wales (AU)

(72) Inventor: Ross Stewart Maclennan, New South Wales (AU)

(21) Appl. No.: 15/022,888

(22) PCT Filed: Sep. 17, 2014
(86) PCT No.: PCT/AU2014/000917

§ 371 Date: Mar. 17, 2016

(30) Foreign Application Priority Data
Sep. 17, 2013 (AU) 2013903579

(51) Int. Cl. G09B 9/12; A63G 31/16

(52) U.S. Cl. CPC G09B 9/12; A63G 31/16

(57) ABSTRACT

A motion device, such as a flight simulator, including a frame including a plurality of roller assemblies mounted thereto and an at least partially rounded body supported on the roller assemblies. The roller assemblies are operable to contact an external surface of the body and to allow movement of the body in a pitch direction, a yaw direction and a roll direction relative to the frame. In an embodiment one or more of the roller assemblies are selectively drivable to controllably drive the movement of the body in the pitch direction, the yaw direction and the roll direction relative to the frame. The motion device provides for control rotation of the body in a desired direction such as the pitch, roll or yaw direction, a desired speed of rotation of the body and a desired acceleration of the body.

### CROSS-REFERENCE TO RELATED APPLICATION

The present application is a national stage filing of International patent application Serial No. PCT/AU2014/000917, filed Sep. 17, 2014, and published as WO 2015/039167 A1 on Mar. 26, 2015, in English.

### FIELD OF THE INVENTION

The present invention relates to a motion device. The present invention is particularly suitable for use as a motion simulating device such as a flight simulating device, however, it is to be appreciated that the present invention may have broader application such as in relation to simulating motion of vehicles other than aircraft, such as motor vehicles, boats, submersibles or the like.

### BACKGROUND OF THE INVENTION

The discussion below is merely provided for general background information and is not intended to be used as an aid in determining the scope of the claimed subject matter.

Motion simulating devices, such as flight simulators, are devices that artificially recreate the sensation of motion within a vehicle, such as an aircraft. Motion simulating devices such as flight simulators can also include means for recreating audio/visual sensations of flight in an aircraft as well as providing controls for enabling a user to provide inputs to control the simulated flight experience. Such devices are particularly useful for the training of pilots as well as in the design and development of aircraft and associated research into aircraft characteristics and control. Flight simulators typically employ hardware including a recreated aircraft cockpit and means for moving the cockpit in a manner that simulates up to six degrees of motion associated with aircraft flight including roll, pitch, yaw, heaving (moving up and down), swaying (moving left and right) and surging (moving forward and backward).

Existing motion simulators are generally large, complex and driven by hydraulics or pneumatics. Hydraulic and/or pneumatic actuators are employed to move the simulated cockpit in three-dimensional space so as to recreate at least some of the above mentioned degrees of freedom of motion. However, hydraulic and pneumatic actuators are typically loud as they require the rapid movement of fluid or gas into cylinders to actuate pistons. Furthermore, hydraulic and pneumatic actuators are relatively large and when employed to move a simulated cockpit typically require the cockpit to be mounted above a platform that is supported on a system of actuators. As such, the entire motion simulator device, including the simulated cockpit, can be several metres in height and thus requires a large enclosed structure to house the simulator device. Such motion simulating devices often require a purpose built structure in which to house the device due to their relative large space requirements. A six-degrees-of-freedom motion platform using five or six hydraulic or pneumatic actuators, known as a Stewart platform, is the gold standard for motion simulating devices. However, existing motion simulator devices, such as flight simulator devices, due to their complexity, size, power requirements and the like are expensive to acquire and maintain.

Some existing flight simulator devices employ electric motors as a means to generate motion of the simulated cockpit. Existing flight simulators employing electric motors as a means to provide motion include a replica cockpit cradled on a sub-frame supported on a base frame. The cockpit is pivotally connected to the sub-frame so as to provide for a first degree of freedom of motion in the form of roll motion of the cockpit relative to the sub-frame and the base frame. The sub-frame is connected to the base frame by a first pivotal connection so as to provide for a second degree of freedom of motion in the form of pitch motion of the cockpit and the sub-frame relative to the base frame. Furthermore, the sub-frame is connected to the base frame by a second pivotal connection to provide for a third degree of motion of the in the form of yaw motion of the cockpit and sub-frame relative to the base frame. As can be appreciated, such an arrangement still requires a relative large space in which to house the simulator device to enable movement of the cockpit and the sub-frame relative to the base frame. In particular, to provide space for the cockpit and the sub-frame to move in a yaw motion (side to side) relative to the base frame. Also, relatively powerful electric motors are required in order to shift the weight of the replica cockpit and sub-frame relative to the base frame.

### SUMMARY OF THE INVENTION

This Summary and the Abstract herein are provided to introduce a selection of concepts in a simplified form that are further described below in the Detailed Description. This Summary and the Abstract are not intended to identify key features or essential features of the claimed subject matter, nor are they intended to be used as an aid in determining the scope of the claimed subject matter. The claimed subject matter is not limited to implementations that solve any or all disadvantages noted in the background.

Accordingly, in one aspect, the present invention provides a motion device including:

a frame including a plurality of roller assemblies mounted thereto; and

an at least partially rounded body supported on the roller assemblies, wherein the roller assemblies are operable to contact an external surface of the body and to allow movement of the body in a pitch direction, a yaw direction and a roll direction relative to the frame.

In an embodiment one or more of the roller assemblies are selectively drivable to controllably drive the movement of the body in the pitch direction, the yaw direction arid the roll direction relative to the frame.

Embodiments of the invention provide for motion (i.e. rotation) of the body in the pitch, roll and yaw directions to be driven in a controlled fashion, which could include a desired direction such as the pitch, roll or yaw direction. Such control of motion of the body could include control of a speed of rotation and/or a rate of change of speed of rotation (i.e. acceleration). Embodiments of the invention may allow for control of a change of direction of rotation of the body. Embodiments of the invention may allow for control of the direction of rotation of the body to include a desired combination of simultaneous rotation in any one or more of the pitch, roll and yaw directions to thereby simulate such motion of a body in three dimensional space such as an aircraft in the air, a submersible underwater, and to some extent a motor vehicle on a road and a boat on the surface of water which also may experience motion in three the pitch, roll and yaw directions.

Each one of the roller assemblies can include a wheel rotatably mounted to the frame so as to rotate about a primary axis of rotation. Each one of the roller assemblies can also include circumferentially spaced apart roller members mounted to the wheel and radially spaced apart from the primary axis of rotation. Each one of the roller members rotates with the wheel about the primary axis of rotation and rotates relative to the wheel about a respective secondary axis of rotation that is transverse to the primary axis of rotation. At least part of the external surface of the body has a spherical shape with a constant radius from a central point, wherein the spherically shaped external surface contacts with at least one of the roller members and is thereby rotatable in any direction about the central point.

In an embodiment, the wheel can include a plurality of sets of the circumferentially spaced apart roller members, in each set the roller members lie in a plane and are the same radial distance apart from the primary axis of rotation. The planes of adjacent sets are parallel and the roller members of one set are a different radial distance apart from the primary axis of rotation than the roller members of an adjacent set. The difference between the radial distance apart from the primary axis of rotation of the roller members of the adjacent sets complements the curvature of the spherical shaped external surface of the body. The plurality of sets of the circumferentially spaced apart roller members provide a concave zone of contact between roller assembly and the external surface of the body. In a preferred form, the roller members of the adjacent sets are staggered relative to each other.

In an embodiment, rotation of one or more of the wheels about the primary axis of rotation is driven by a drive motor. In another embodiment, rotation of each one of the roller members relative to the wheel about its respective secondary axis of rotation is passive.

The roller assemblies are preferably mounted to the frame such that the primary axis of rotation is parallel to a tangent of the spherically shaped external surface of the body. The roller assembly is substantially biconcave in longitudinal section.

In one form, the device includes three of the roller assemblies mounted to the frame in a circle at 120 degree intervals. In another form, the device includes four of the roller assemblies mounted to the frame in a circle at 90 degree intervals.

Preferably, at least a portion of the external surface of the rounded body for engagement with the roller members is the shape of a segment of a sphere.

The device can also include a user control input for a user to select a movement of the rounded body in any one or a combination of the pitch direction, the yaw direction and the roll direction and a control system for determining a selection of the one or more roller assemblies to be driven to drive the selected movement of the rounded body.

Preferably, the motion device is a motion platform for a flight simulator apparatus. Accordingly, the rounded body may contain a simulated aircraft cockpit.

In another aspect, the present invention provides a method of operation of a motion device including a frame including a plurality of roller assemblies mounted thereto arid a rounded body supported on the roller assemblies wherein the roller assemblies are operable to contact an external surface of the rounded body and to allow movement of the rounded body in a pitch direction, a yaw direction and a roll direction relative to the frame, the method including selectively driving rotation of one or more of the roller assemblies to drive the movement of the rounded body in the pitch direction, the yaw direction and the roll direction relative to the frame.

Preferably, each one of the roller assemblies includes a wheel rotatably mounted to the frame so as to rotate about a primary axis of rotation and circumferentially spaced apart roller members mounted to the wheel and radially spaced apart from the primary axis of rotation, each one of the roller members rotates with the wheel about the primary axis of rotation and rotates relative to the wheel about a respective secondary axis of rotation that is transverse to the primary axis of rotation, wherein selectively driving rotation of one or more of the roller assemblies includes selectively driving rotation of one or more of the wheels about the primary axis of rotation.

The method preferably includes selectively driving rotation of one or more of the wheels about the primary axis of rotation in a clockwise or a counter clockwise direction at a determined speed of rotation. In yet another preferred embodiment, the method includes receiving a user control input indicative of a selected movement of the rounded body in any one or a combination of the pitch direction, the yaw direction and the roll direction; arid determining a selection of the one or more roller assemblies to be driven to drive the selected movement of the rounded body. Determining a selection of the one or more roller assemblies to be driven to drive the selected movement of the rounded body preferably includes determining the speed and direction of rotation of one or more of the roller assemblies about their respective primary axes of rotation.

In yet another aspect, the present invention provides a roller assembly adapted to be mounted to a frame and for contacting an external surface of an at least partially rounded body to allow movement of the body in a pitch direction, a yaw direction and a roll direction relative to the frame, the roller assembly including:

a wheel rotatably mounted to the frame so as to rotate about a primary axis of rotation; and

circumferentially spaced apart roller members mounted to the wheel and radially spaced apart from the primary axis of rotation, each one of the roller members rotates with the wheel about the primary axis of rotation and rotates relative to the wheel about a respective secondary axis of rotation that is transverse to the primary axis of rotation;

wherein at least part of the external surface of the body has a spherical shape with a constant radius from a central point, wherein the spherically shaped external surface contacts with at least one of the roller members and is thereby rotatable in any direction about the central point.

The wheel can include a plurality of sets of the circumferentially spaced apart roller members, in each individual set the roller members lie in a plane and are the same radial distance apart from the primary axis of rotation, and the roller members of adjacent sets lie in parallel planes and are different radial distances apart from the primary axis of rotation.

The difference between the radial distance apart from the primary axis of rotation of the roller members of adjacent sets preferably complements the curvature of the spherical shaped external surface of the body.

Preferably, the plurality of sets of the circumferentially spaced apart roller members provide a concave zone of contact between roller assembly and the external surface of the body.

Preferably, the roller members of the adjacent sets are staggered relative to each other.

### BRIEF DESCRIPTION OF THE DRAWINGS

Aspects of the present invention will now be described in more detail with reference to the preferred embodiments of the invention set out in the accompanying Figures, in which:

FIG. 1 illustrates a perspective view of a motion device in accordance with an embodiment of the invention, wherein the motion device is a flight simulator;

FIG. 2 illustrates a perspective view of the motion device of FIG. 1, wherein a portion of a shroud is removed that surrounds a rounded body containing a replica aircraft cockpit supported on four roller members connected to a frame;

FIG. 3 illustrates a perspective view of the motion device of FIG. 1, wherein the entire shroud and a portion of the rounded body have been removed to reveal the arrangement of the replica cockpit contained within the rounded body;

FIG. 4a illustrates a top view of the motion device of FIG. 1, illustrating, in particular, the rounded body supported on roller assemblies and a frame and the location of the roller assemblies in a circle at 120 degree intervals;

FIG. 4b illustrates a side view of a section of the motion device taken along section line 4b-4b of FIG. 4a, illustrating, in particular, the rounded body supported on the roller assemblies and the frame;

FIG. 5 illustrates a perspective view of one of the roller assemblies of the motion device of FIG. 1;

FIG. 6 illustrates a front view of the roller assembly of FIG. 5;

FIG. 7a illustrates a cross section of the roller assembly of FIG. 5;

FIG. 7b illustrates a partially exploded perspective view of the roller assembly of FIG. 5;

FIG. 8 illustrates a longitudinal section view of the roller assembly of FIG. 5 and a concave zone of contact between roller assembly and the external surface of the body, although it is to be appreciated that in FIG. 8 the aligned relative positioning of roller members in adjacent sets is not representative of the staggered positioning of the roller members of embodiments illustrated in other figures;

FIG. 9 illustrates a side view of a portion of the motion simulating device of FIG. 1, including a portion of the body supported on one of the roller assemblies which in turn is supported on the frame and coupled to a drive means.

The present invention will now be described in more detail below with reference to the preferred embodiments of the invention illustrated in the Figures.

### DETAILED DESCRIPTION OF THE ILLUSTRATIVE EMBODIMENTS

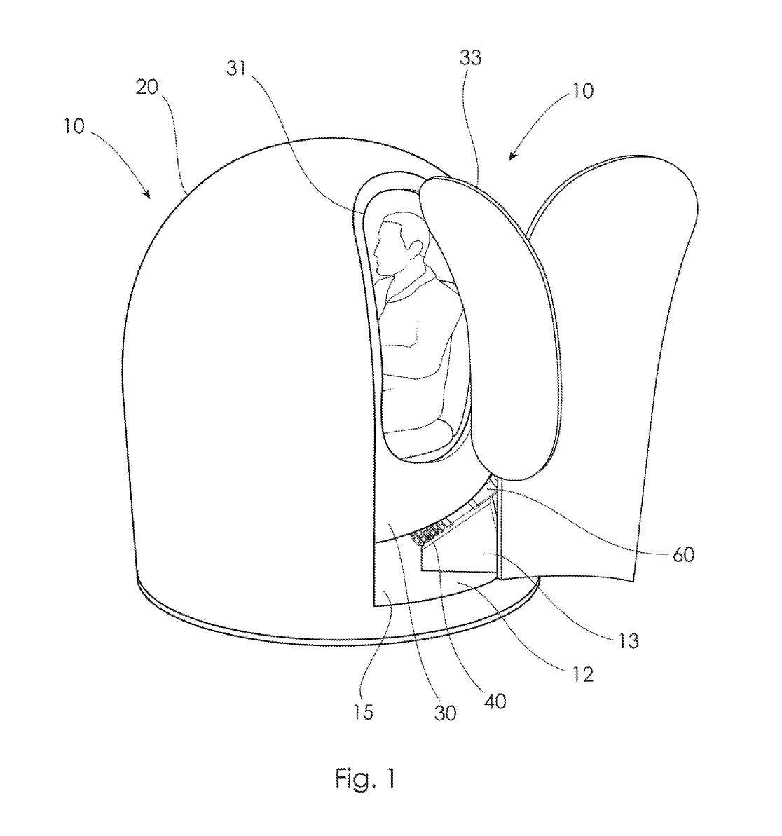

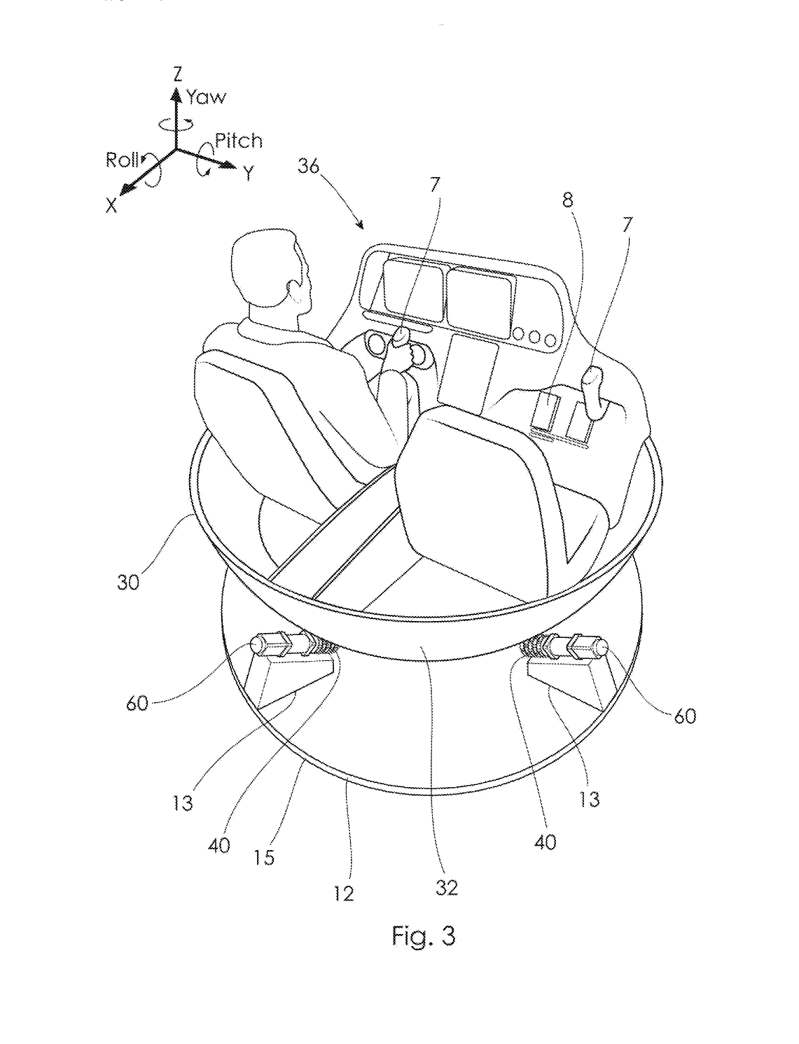

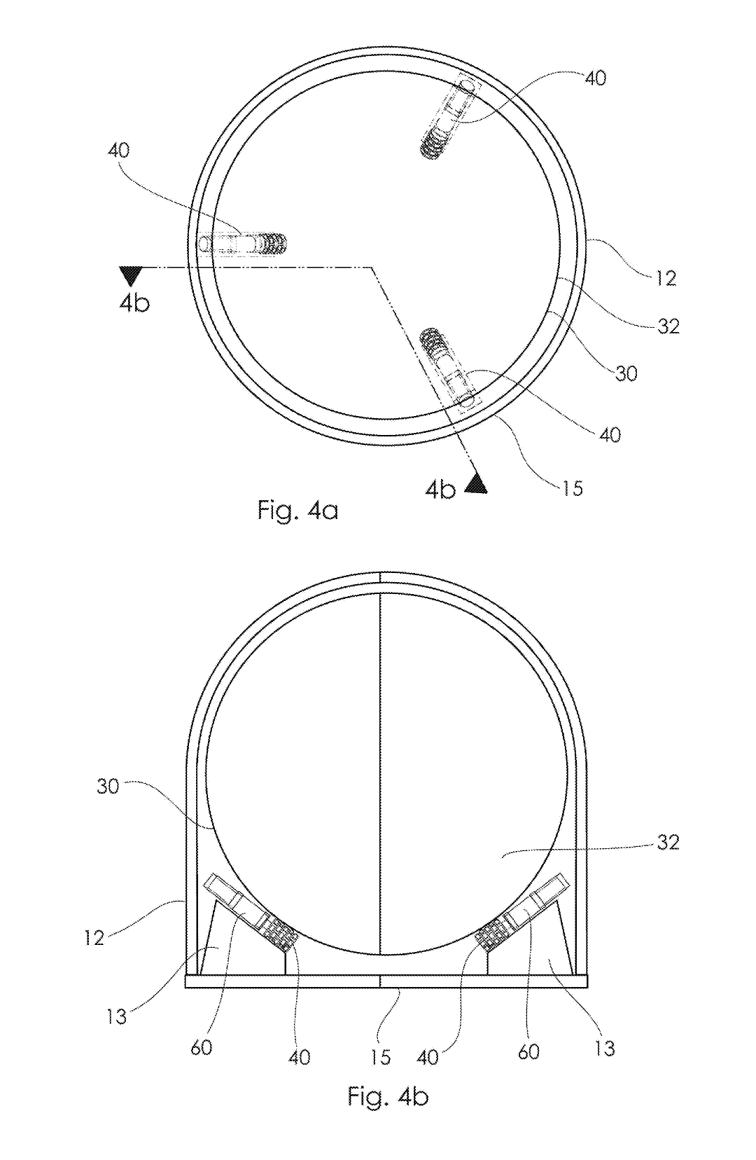

Referring to FIGS. 1 to 3, 4a and 4b, there is shown a motion device 10 in accordance with a preferred embodiment of the invention. The motion device 10 is in the form of a flight simulator although it is to be appreciated that embodiments of the motion device 10 could be configured for use to simulate motion of other vehicles, such as motor vehicles, boats, submersibles or the like. The device 10 includes a frame 12 and a plurality of roller assemblies 40 mounted to the frame 12 and an at least partially rounded body 30 supported on the roller assemblies 40. Each one of the roller assemblies 40 is operable to contact an external surface 32 of the body 30 and to allow movement of the body 30 in a pitch direction, a yaw direction and a roll direction relative to the frame 12. As will become apparent from the foregoing description, in embodiments of the invention, the roller assemblies 40 are selectively drivable to drive movement of the body 30 in a pitch direction, a yaw direction and a roll direction and any combination thereof relative to the frame 12. Thus, as illustrated in FIG. 3 the motion device 10 provides for three degrees of freedom of rotation of the body 30 in the pitch, roll and yaw directions about the Y, X and Z axes respectively relative to the frame 12 and a surface or support upon which the frame 12 rests or is supported.

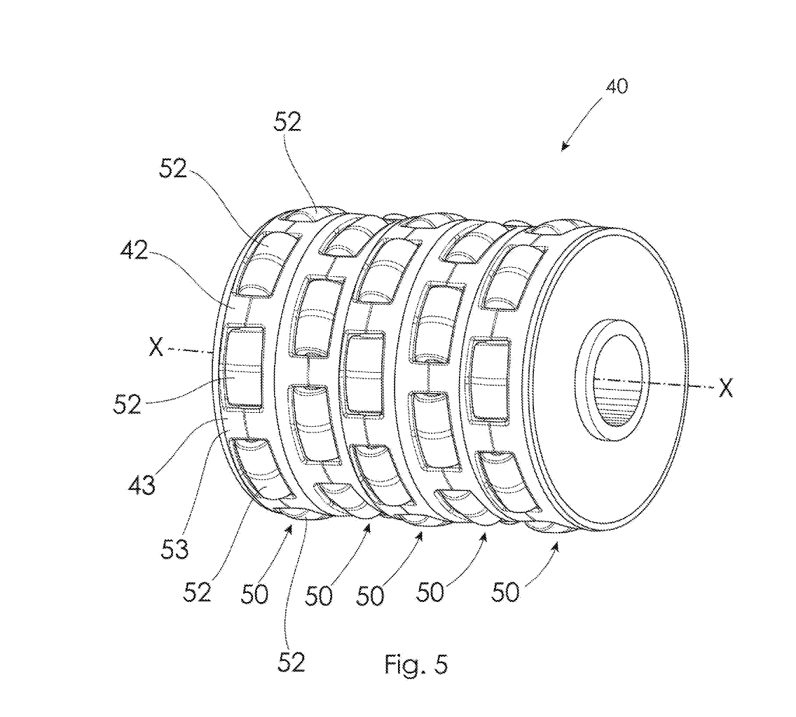

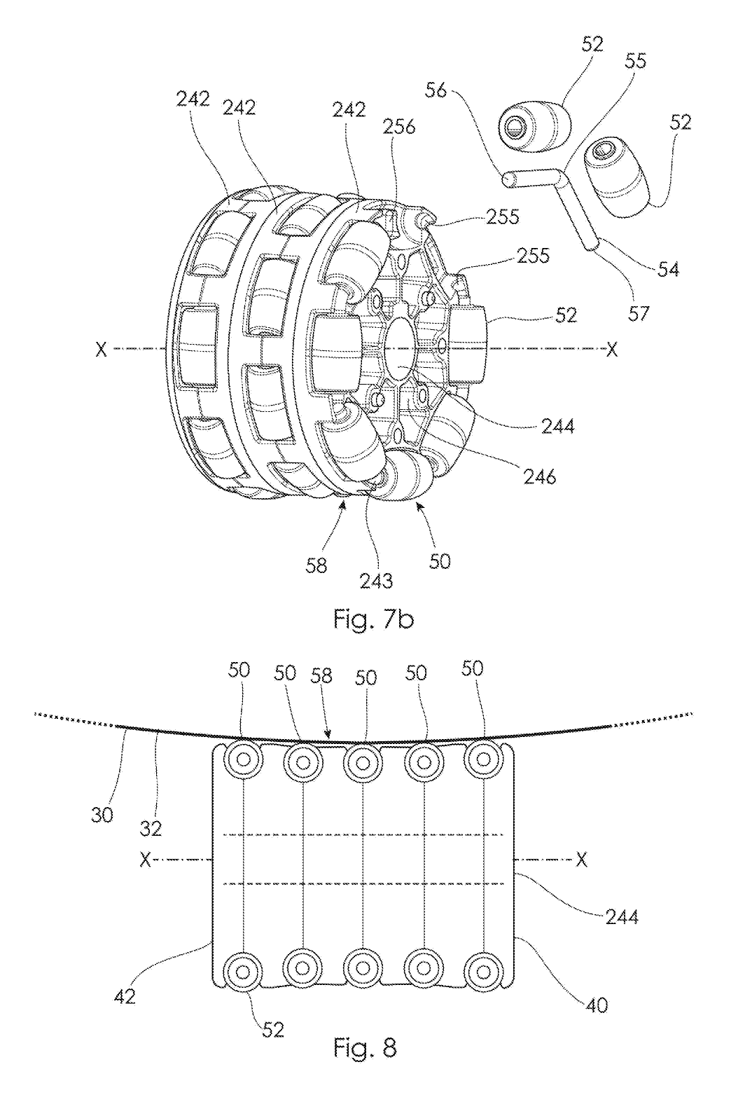

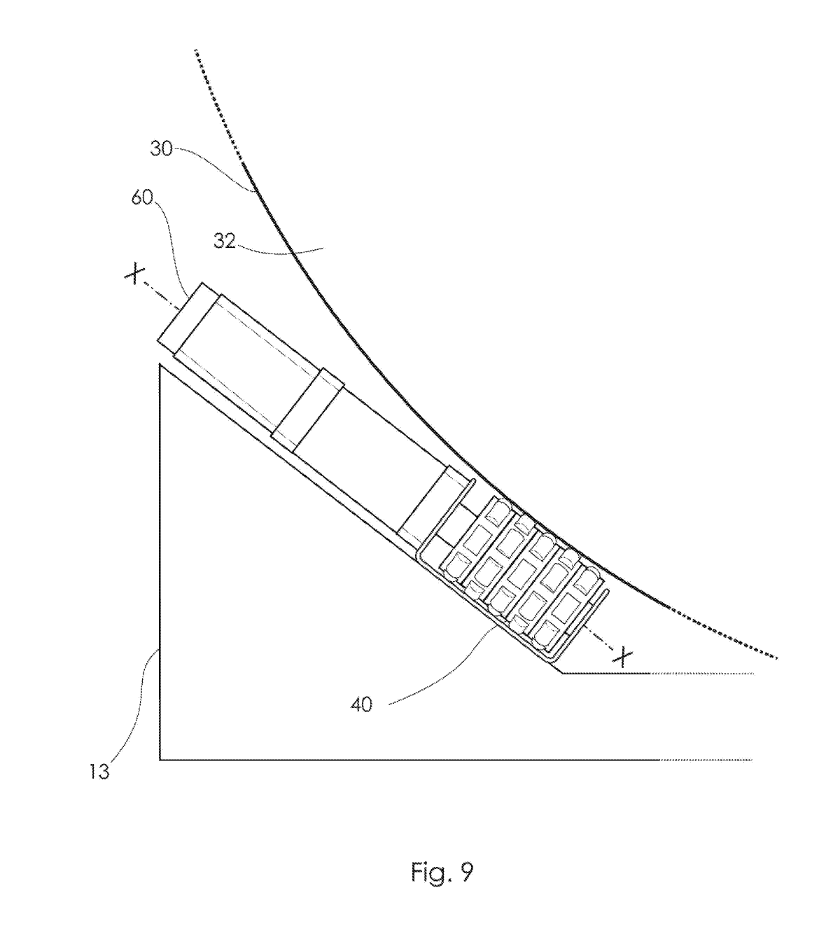

FIGS. 5 to 8 illustrate an embodiment of the roller assembly 40 as used in the motion device 10. The roller assembly 40 includes a wheel 42 and a plurality of roller members 52. The wheel 42 is rotatably mounted to the frame 12, as illustrated in FIGS. 1 to 3, 4a, 4b and 9 so as to rotate about a primary axis of rotation X-X of the wheel 42. As shown in FIGS. 5, 7a and 7b in particular, the plurality of roller members 52 are mounted to the wheel 42 in a circumferentially spaced apart fashion and also radially spaced apart from the primary axis of rotation X-X. Thus, each one of the roller members 52 rotates with the wheel 42 about the primary axis of rotation X-X. Also, each one of the roller members 52 rotates relative to the wheel 42 about its own respective axis of rotation, referred to herein as a secondary axis of rotation Y-Y as illustrated in FIG. 7a. The respective secondary axis of rotation Y-Y of each roller member 52 is transverse to the primary axis of rotation X-X. It is to be appreciated that each individual roller member 52 of the roller assembly 40 has its own secondary axis of rotation Y-Y which may run in the same direction as, but will not be aligned with, the secondary axis of rotation Y-Y of other roller members 52 of the same roller assembly 40.

Referring to FIGS. 5, 6, 7a and 7b, the roller members 52 are rotatably mounted near and about the circumference of the wheel 42 and are each operable to rotate about their respective secondary axes of rotation Y-Y. As illustrated in FIG. 7a, the secondary axes of rotation Y-Y of the roller members 52 are along secant lines cutting across the circumference of the wheel 42. Thus, the secondary axes of rotation Y-Y of the roller members 52 are perpendicular to a radius extending from the primary axis of rotation X-X of the wheel 42. In the embodiments illustrated in the Figures, the secondary axes of rotation Y-Y of the roller members 52 are also at an angle of about 90 degrees to the primary axis of rotation X-X of the wheel 42. It is to be appreciated, however, that the secondary axes of rotation Y-Y of the roller members 52 may run at any angle relative to the primary axis of rotation X-X of between 0 and 90 degrees such that the roller members 52 can rotate in a direction at an angle transverse to the direction of rotation of the wheel 42. Thus, the roller members 52 are operable to rotate relative to the wheel 42 and are also operable to rotate with the wheel 42 about the primary axis of rotation X-X.

As can be seen in FIGS. 5, 6, 7b and 8, the roller assembly 40 includes a plurality of sets 50 of the circumferentially spaced apart roller members 52. In each one of the sets 50, the roller members 52 lie in a plane. The planes in which the roller members 52 of each set 50 lie are parallel to each other and perpendicular to the axis of rotation X-X of the wheel 42. Thus, the roller assembly 40 includes a plurality of sets 50 of the roller members 52 arranged in parallel planes. The roller members 52 within each set 50 are circumferentially spaced apart and are equidistant (i.e. the same radial distance apart) from the primary axis of rotation X-X.

As can be seen in FIGS. 5, 6, 7b and 8 the roller assembly 40 includes a plurality of adjacent sets 50 of the circumferentially spaced apart roller members 52. The roller members 52 of one of the sets 50 are a different radial distance apart from the primary axis of rotation than the roller members 52 of one or both adjacent sets 50. Furthermore, the roller members 52 of each of the sets 50 are staggered relative to the roller members 52 of the adjacent set 50. A space 53 is provided between adjacent roller members 52 within a set 50 by virtue of their circumferential spacing. The space 53 is traversed or spanned by one of the roller members 52 of the adjacent set 50. Thus, when the external surface 32 of the body 30 rests upon the roller assembly 40, regardless of the relative rotational position of the wheel 42 of the roller assembly 40 to the external surface 32 of the body 30, at any time the external surface 32 will be in contact with at least one of the roller members 52 of at least one of the sets 50.

FIG. 7a illustrates a cross section of the roller assembly 40. In each of the roller assemblies 40, the roller members 52 are rotatably mounted to the wheel 42 by way of an axle member 54. The axle member 54 is an elongated rod having a bend 55 at a mid-point along the axle member 54. The axle 54 has two ends 56, 57 that are on opposite sides of the bend 55. The axle 54 is mounted to the wheel 42 and a pair of the roller members 52 are rotatably mounted to the ends 56, 57 of the axle 54. Thus, the roller members 52 mounted to the axle member 54 are operable to rotate about their own individual (i.e. respective) axis of rotation Y₁-Y₂, Y₂-Y₂ at an angle to each other equivalent to the angle of the bend 55 of the axle member 54.

FIG. 7b illustrates a partially exploded perspective view of the roller assembly 40 illustrating how the roller assembly 40 is comprised of a plurality of wheel segments 242. Each wheel segment 242 includes a central passage 244 and a radially outwardly extending support member 246 extending to a plurality of circumferentially spaced apart bearing surfaces 255. Between successive pairs of bearing surfaces 255 is a recess 256. Pairs of the wheel segments 242 are brought together such that their central passages 244 are aligned about the primary axis of rotation X-X of the wheel 42 and bearing surfaces 255 and recesses 256 of the adjacent wheel segments 242 also are aligned to receive the axles 54 and the roller members 52. The aligned bearing surfaces 255 of adjacent wheel segments 242 capture the axles 54 whereby the bend 55 is received between one pair of aligned bearing surfaces 255 and the two ends 56, 57 are received between other pairs of aligned bearing surfaces 255. The roller members 52 are rotatably mounted to the two ends 56, 57 of the axle members 54 and are located within aligned pairs of recesses 256. The roller members 52 protrude radially outwardly from the aligned recesses 256 about a circumference of the assembled wheel 42 so as to provide one of the sets 50 of roller members 52. As can be seen in FIGS. 5, 6 and 7b the wheel 42 is assembled to include a plurality of the sets 50 of the roller members 52 by assembling a plurality of adjacent wheel segments 242, axle members 54 and roller members 52 as described above.

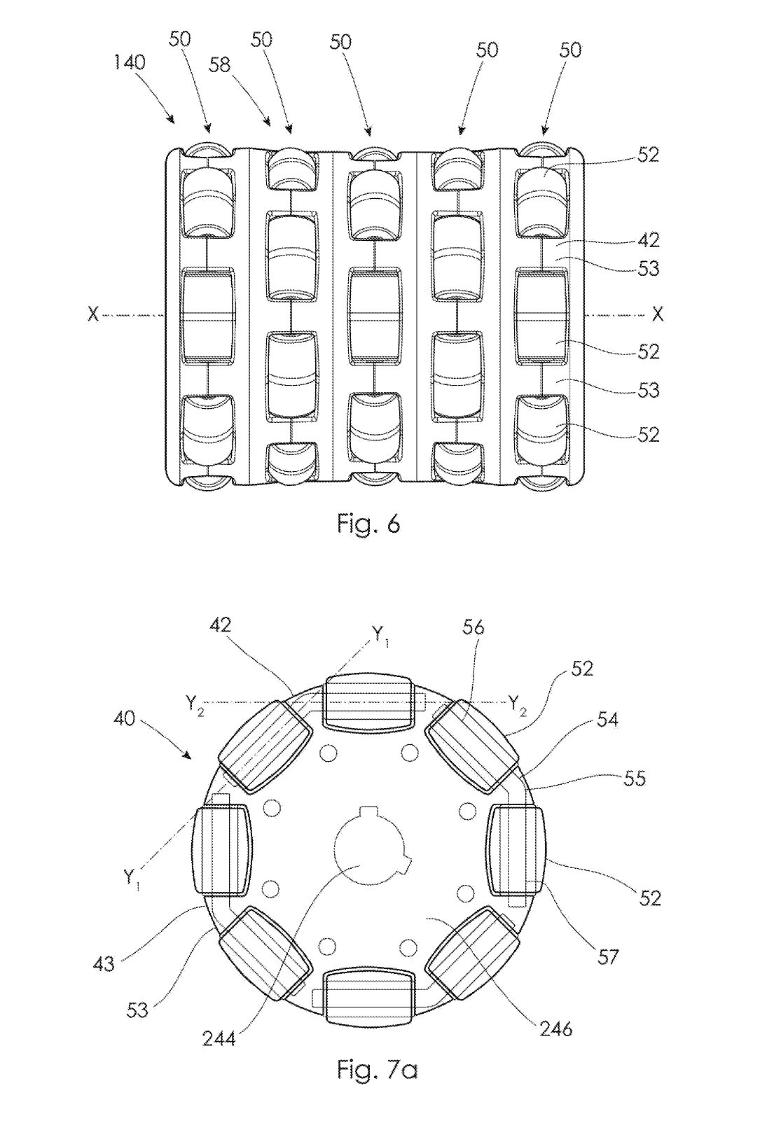

As can be seen in FIGS. 6, 7b and 8, the radial distance from the primary axis of rotation X-X of all of the roller members 52 in each set 50, considered separately, is the same. However, the radial distance of the roller members 52 from the primary axis of rotation X-X in one set 50 is different to that of an adjacent set 50. The embodiment of the roller assembly 40 illustrated in FIGS. 5, 6, 7b includes five sets 50 of roller members 52 in which the roller members 42 in the middle set 50 are radially spaced apart from the primary axis of rotation X-X by the smallest distance. The roller members 42 of the sets 50 either side of the middle set 50 are radially spaced apart from the primary axis of rotation X-X by a larger distance than the middle set 50. The roller members 42 of the sets 50 at opposite ends of the wheel 42 are radially spaced apart from the primary axis of rotation X-X by a larger distance than the sets 50 either side of the middle set 50. The difference between the radial distances of the roller members 52 apart from the primary axis of rotation X-X of adjacent sets 50 is related to, and thereby complements, the curvature external surface 32 of the body 30. Thus, as illustrated in FIG. 8, the sets 50 of the roller members 52 define a concave zone of contact 58 between the roller assembly 40 and the external surface 32 of the body 30. The concave zone of contact 58 complements the curvature of the spherical shaped external surface 32 of the body 30 so as to ensure that the roller members 52 of each of the sets 50 can contact the external surface 32 of the rounded body 30.

Preferably, the roller assembly 40 includes five sets 50 of the roller members 50 as with this configuration at least two roller members 52 of two different sets 50 are in contact with the external surface 32 of the body 30 at any given time. Such is advantageous in providing sufficient friction between the roller assembly 40 and the external surface 32 of the body 30 to enable effective and controlled driving of rotational motion of the body 30 as described herein. However, the roller assembly 40 could include other odd numbers of sets such as three or seven etc. or it could include even numbers of sets such as two, four six etc.

In the embodiments of the motion device 10 illustrated in the Figures, at least part of the external surface 32 of the body 30 has a spherical shape with a constant radius from a central point (not shown). The spherically shaped external surface 32 is supported on and contacts the roller members 52 of the roller assembly 40. It is to be appreciated that the entire external surface 32 of the body need not be spherical but rather only the part or parts that contact the roller members 52. In an embodiment, at least a portion of the external surface 32 of the body 30 for engagement with the roller members 42 is the shape of a segment of a sphere. Given that the wheel 40 of the roller assembly 40 is operable to rotate about the primary axis of rotation X-X and the roller members, upon which the external surface 32 is supported, are operable to rotate about the secondary axis of rotation Y-Y, which is transverse and preferably 90 degrees to the primary axis of rotation X-X, the external surface 32 is rotatable in any direction about the central point. To put it another way, the rotation of the wheel 40 relative to the external surface 32 of the body 30 about the X-X axis provides for rotation of the body 30 in a first direction (i.e. an X axis) whilst rotation of the roller members 52 relative to the external surface 32 of the body 30 about their secondary axes of rotation Y-Y provides for rotation of the body 30 in a second direction (i.e. a Y axis). Thus, the roller assembly 30 facilitates movement of the external surface 32 of the body 30 relative to each one of the roller assemblies 30 in any direction in the X and Y (i.e. horizontal and vertical) axes. Because the external surface 32 of the body 30 is rounded and preferably spherical the movement of the body 30 is rotational, in any direction, about the central point of the spherical surface.

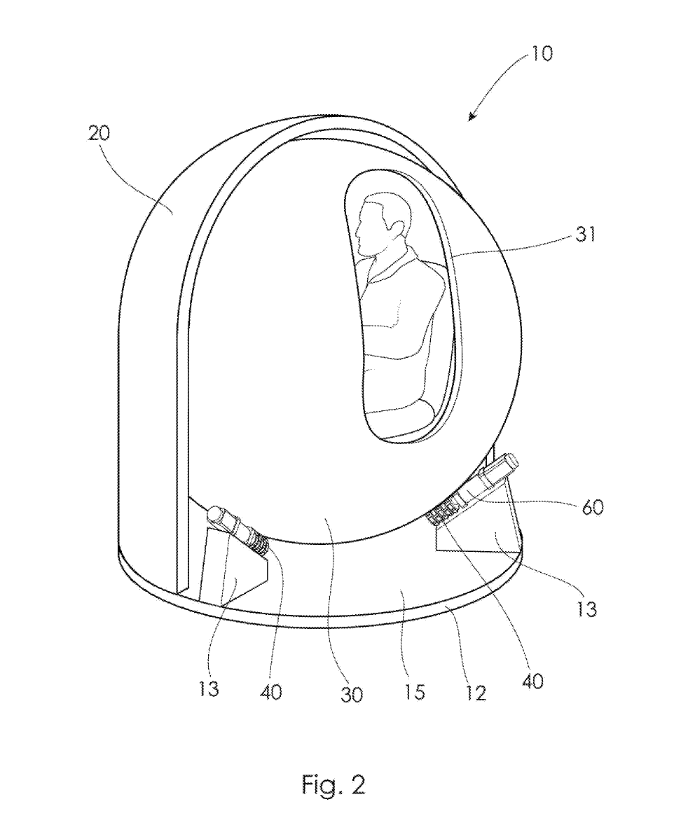

As illustrated in FIGS. 2, 3 and 4a, the device 10 includes three of the roller assemblies 40 mounted to the frame 12 in a circle at 120 degree intervals. In another embodiment, not illustrated, the device 10 could include four of the roller assemblies 40 mounted to the frame 12 at 90 degree intervals. In other embodiments, not illustrated, the device 10 includes five or six or seven or eight or nine or more of the roller assemblies 40 mounted to the frame 12. An arrangement including three of the roller assemblies 40, or an odd number of the roller assemblies 40 such as five or seven etc. is preferable. This is because it was discovered that the adoption of an even number of roller assemblies 40 could result in an undesirable rocking of the body 30 on directly opposite pairs of the roller assemblies 40 which occurs in arrangements including even numbers of the roller assemblies 40 located equidistant intervals from each other. Nevertheless, it is to be appreciated that even numbers of roller assemblies 40 such as four, six etc. could be employed.

Furthermore, each one of the roller assemblies 40 is coupled to a respective drive means 60, such as an electric or pneumatic motor or like device, capable of driving rotation of the roller assembly 40, including the wheel 42 and the roller members 52 mounted thereto, about the primary axis of rotation X-X thereof. Rotation of each roller assembly 40 can be selectively driven by the drive means 60 in the clockwise or anti-clockwise directions about the primary axis of rotation X-X. Each roller assembly 40 can also passively rotate in the clockwise or anti-clockwise directions about the primary axis of rotation X-X. Rotation of each of the roller members 52 about their secondary axis of rotation Y-Y relative to the wheel 42 is passive but could also be driven by a drive means (not shown).

As will be described below, the various drive means 60 can be controlled so as to drive rotation of each of the three roller assemblies 40 about their respective primary axis of rotation X-X in a manner so as to drive movement (i.e. rotation) of the body 30 relative to the frame 12 in the pitch direction, the yaw direction and the roll direction, one at a time or in any combination thereof simultaneously.

For example, in the case where there are three or four of the roller assemblies 40, if all three drive means 60 associated with all three or four roller assemblies 40 are simultaneously operated to drive rotation of the roller assemblies 40 in the same direction about their respective primary axis of rotation X-X (i.e. clockwise or anticlockwise) then the body 30 will be caused to rotate in a yawing motion, that is to turn left or right depending on the direction of rotation of the roller assemblies 40.

In the case where there are four of the roller assemblies 40, operation of two of the drive means 60 associated with two of the roller assemblies 40 located on opposite sides of the body 30 and spaced apart by 180 degrees from each other, such as on the left and right hand sides of the body 30, so as to cause rotation of the two roller assemblies 40 in opposite directions about their respective primary axis of rotation X-X (i.e. clockwise and anticlockwise) will cause movement of the body 30 in a pitching motion, that is tilting forward or backward, depending on the direction of rotation of the roller assemblies 40. In respect of the remaining two non-driven roller assemblies 40, which are also on opposite sides of the body 30 and that are spaced apart at 90 degree intervals to the driven roller assemblies 40, the roller members 52 are operable to passively rotate about their secondary axis of rotation Y-Y transversely relative to the wheels 42. Thus, the passively rotatable roller members 42 allow the external surface 32 of the body 30 to move transversely relative to the wheels 42 of the non-driven roller assemblies 40. The non-driven roller assemblies 40 do not hinder the movement of the body 30 in the transverse direction relative to the wheels 42. Similarly, operation of the drive means 60 associated with the previously non-driven roller assemblies 40, which are located on opposite sides of the body 30 and at 90 degree intervals to the previously driven pair of the roller assemblies 40, so as to cause rotation of the two roller assemblies 40 in opposite directions about their respective primary axis of rotation X-X (i.e. clockwise and anticlockwise) will cause movement of the body 30 in a rolling motion, that is tilting side to side. Similarly as for the pitching motion of the body 30, when the body 30 moves in the rolling motion the roller assemblies 40 that are not being driven do not hinder the movement of the body 30 in the transverse direction relative to the wheels 42.

In the case where there are three of the roller assemblies 40, such as is illustrated in the Figures, operation of the drive means 60 associated with the three roller assemblies 40 to cause the movement of the body 30 in the pitch direction, the yaw direction and the roll direction, one at a time or any combination thereof simultaneously, is somewhat more complicated. For example, in the case where there are three of the roller assemblies 40, if all three drive means 60 associated with all three of the roller assemblies 40 are simultaneously operated to cause rotation of the roller assemblies 40 in the same direction about their respective primary axis of rotation X-X (i.e. clockwise or anticlockwise) then the body 30 will be caused to move in a yawing motion, that is to turn left or right depending on the direction of rotation of the roller assemblies 40.

In the case where there are three of the roller assemblies 40, operation of two of the drive means 60 associated with two of the roller assemblies 40 located and spaced apart by 120 degrees from each other, such as on the left rear and right rear of the body 30, so as to cause rotation of the two roller assemblies 40 in opposite directions about their respective primary axis of rotation X-X (i.e. clockwise or anticlockwise) will cause movement of the body 30 in a pitching and/or rolling motion, that is tilting forward or backward or side to side or a combination thereof, depending on the direction of rotation of the roller assemblies 40. If the speed of rotation of the roller assemblies 40 is identical then the body 30 will pitch in a direction bisecting the angular displacement between the roller assemblies 40 that are so driven. If the speed of rotation of the driven roller assemblies 40 is not the same then this will alter the direction of pitch of the body 30 to some direction between the two driven roller assemblies 40. Thus, depending on which two roller assemblies 40 are being so driven in opposite directions about their respective primary axis of rotation X-X and depending on the relative speed of such rotation will determine the direction of pitch or roll or both of the body 30 which may be in any direction in 360 degrees about the body 30.

In each of the scenarios described above with respect to the embodiment comprising three of the roller assemblies 40, in respect of the remaining non-driven roller assembly 40 the passively rotatable roller members 52 which are operable to rotate transversely about their secondary axes of rotation Y-Y relative to the wheels 42, enables the external surface 32 of the body 30 to freely move transversely relative to the wheels 42 of the non-driven roller assembly 40. Thus, the non-driven roller assembly 40 does not hinder the movement of the body 30 in the transverse direction relative to the wheels 42.

As can be appreciated, rotation of various combinations of the roller assemblies 40 in various combinations of directions can be driven by the various drive means 60 so as to cause rotation of the body 30 relative to the frame 12 in the pitch direction, the yaw direction and the roll direction, one at a time or any combination thereof simultaneously. Thus, the body 30 provides a platform for a simulated aircraft cockpit 36, such as is illustrated in FIGS. 1 to 3, whereby a person within the simulated cockpit 36 can experience 3 degrees of freedom of motion in the pitching direction, the yawing direction and the rolling direction.

It is to be appreciated that any form of roller member capable of enabling the body 30 to rotate about the central point by allowing the body 30 to roll over the roller member in any direction could fall within the scope of the present invention. In this regard, another example of a roller member that could be employed in the present invention is a Mecanum wheel and any other form of omni-wheel or poly-wheel capable of enabling the rounded body 30 to roll over the roller member in any direction yet being capable of being rotatably driven about at least one axis of rotation. However, it has been found that the embodiments of the roller assemblies 40 disclosed herein are advantageous over other roller assemblies because, for example: they are able to be manufactured at less expense and are less complex than other solutions such as Mecanum wheels; they are capable of supporting the weight of the rounded body including internal cockpit components and the weight of one or more users; they are capable of driving rotation of the body 30 in the pitch, roll and yaw directions with sufficient accuracy and speed to provide for the realistic sensation of movement. In any event, whilst other forms of roller assemblies might be capable of driving rotation of the body 30 with three degrees of freedom of movement such roller assemblies have, hitherto, only been used for the purpose of moving a vehicle over a surface or as stationary rollers for allowing objects to translate over the stationary rollers in different directions in two dimensions.

As mentioned above and as illustrated in FIGS. 1 to 4 and 9, at least a portion of the external surface 32 of the body 30 that is for engagement with the roller assemblies 40 is the shape of a segment of a sphere. For example, as illustrated in the embodiment of FIGS. 1 to 4 and 9 the external surface 32 of the body 30 includes a spherical lower-most portion. The simulated cockpit 36 is mounted within the body 30 and an uppermost portion of the rounded body 30 also has a spherical shape, though it need not be so, to enclose simulated cockpit 36 within the body 30. The body 30 includes an access opening 31 that is operable to enable a person to access the simulated cockpit 36 within the body 30. A door 33 is provided to open and close the access opening 31.

The frame 12, upon which the plurality of drive means 60, roller assemblies 40 and the body 30 are mounted and supported, includes, as illustrated in the FIGS. 1 to 3, 4a and 4b, where there are three roller assemblies 40 a trio of support members 13, 14 that are arranged perpendicular to each other. The frame 12 further includes a base plate 15 upon which the support members 13 are mounted. The roller assemblies 40 are mounted to the support members 13 such that the primary axis of rotation X-X of each of the roller assemblies 40 is at an incline relative to the horizontal and to the base plate. The angle at which the primary axis of rotation X-X of each of the roller assemblies 40 is mounted relative to the horizontal may be any suitable angle such as 30° or 45° or any angle between 0° and 90° and preferably at an angle that is tangential to the curvature of the spherical portion of the external surface 32 of the body 30.

The drive means 60 associated with each one of the roller assemblies 40 is controlled by a control system (not shown) which may include a computerised control system that is operable to variously operate the drive means 60 to cause rotation of one or more of the roller assemblies 40 in either rotational direction about their primary axes of rotation X-X. The control system is operable to receive instructions from a user control input 7, such as a flight control stick, wheel (not shown) or pedals 8 in the simulated cockpit 36, indicative of a selected movement of the rounded body in any one or a combination of the pitch direction, the yaw direction and the roll direction. A user operates the use control input 7 in the appropriate manner, such as tilting the stick and/or depressing one or other of the pedals, to select a desired movement of the body 30 in any one or a combination of the pitch direction, the yaw direction and the roll direction. The control system receives a signal from the user control input indicative of a selected movement of the rounded body in any one or a combination of the pitch direction, the yaw direction and the roll direction and determines a selection of the one or more roller assemblies 40 to be driven, and the direction and speed of rotation of each of the one or more roller assemblies, to drive the selected movement of the body 30. The control system selectively causes the drive means 60 to drive rotation of one or more of the roller assemblies 40 according to the determination made as to which of the one or more roller assemblies 40 must be driven to drive the selected movement of the body 30.

The control system is operable to control the drive means 60 so as to cause the rounded body 30 to move in the pitch direction, the yaw direction and the roll direction relative to the frame 12, or any combination thereof either simultaneously or separately, so as to simulate the sensation of flying an aircraft, or in the case of motion simulating devices other than flight simulators, driving a motor vehicle or the like. The control system is responsive to user inputs into control inputs 7 such as a flight control stick, wheel, pedals or the like mounted within the simulated cockpit 36 to move the rounded body 30, and the cockpit 36, in response to the user inputs and in response to other input from software replicating the movement of a simulated aircraft in a simulated environment. The user control devices 7, which may include devices such as a wheel, stick, pedals, levers, switches and the like are connected either via a wired connection or a wireless connection to the control system to transmit user inputs to the control system.

The present invention is advantageous in that it provides a motion device that, in an embodiment, can be configured as a flight simulator that can recreate three degrees of motion namely pitch, roll and yaw. Another advantage of the present invention, is that the rounded body containing the cockpit is moved in the pitch, roll and yaw directions about a central point which remains stationary thus meaning that the entire weight of the rounded body and the cockpit and a person contained therein, need not be shifted away from the central point so as to recreate the yaw motion in particular. Thus, the present invention requires less powerful motors and less energy to simulate the yaw motion for example. Furthermore, the present invention provides a motion device that is relatively compact, requires a relatively smaller space in which to operate in comparison to existing motion devices configured for use as a flight simulator providing the pitch, roll and yaw degrees of freedom of motion. Thus, the present invention, in the form of a flight simulator device, can be contained within a room of an existing building and does not require an oversize or purpose built room to contain it. Also, in an embodiment of the motion device which is covered by a shroud, the device may be located outdoors and is protected from the elements by the shroud. Furthermore, by utilising motors such as electric motors to recreate motion, embodiments of the present invention can be less noisy and more cost effective to operate and maintain than existing motion devices using hydraulic or pneumatic linear actuators.

It is to be understood that various alterations, modifications and/or additions may be made to the method and/or to the lightweight panel without departing from the ambit of the present invention as disclosed herein.

1. A motion device including:
a frame including a plurality of roller assemblies mounted thereto wherein each one of the roller assemblies includes a wheel rotatably mounted to the frame so as to rotate about a primary axis of rotation and a plurality of sets of circumferentially spaced apart roller members mounted to the wheel and radially spaced apart from the primary axis of rotation, each one of the roller members rotates with the wheel about the primary axis of rotation and rotates relative to the wheel about a respective secondary axis of rotation that is transverse to the primary axis of rotation wherein the wheel includes a plurality of sets of the circumferentially spaced apart roller members, in each set the roller members lie in a plane and are the same radial distance apart from the primary axis of rotation, and wherein the planes of adjacent sets are parallel and the roller members of one set are a different radial distance apart from the primary axis of rotation than the roller members of an adjacent set; and
an at least partially rounded body supported on the roller assemblies, wherein the roller assemblies are operable to contact an external surface of the body and to allow movement of the body in a pitch direction, a yaw direction and a roll direction relative to the frame.

2. The device of claim 1, wherein one or more of the roller assemblies are selectively drivable to controllably drive the movement of the body in the pitch direction, the yaw direction and the roll direction relative to the frame.

3. The device of claim 1,
wherein at least part of the external surface of the body has a spherical shape with a constant radius from a central point, wherein the spherically shaped external surface contacts with at least one of the roller members and is thereby rotatable in any direction about the central point.

4. (canceled)

5. The device of claim 1, wherein the difference between the radial distance apart from the primary axis of rotation of the roller members of adjacent sets complements the curvature of the spherical shaped external surface of the body.

6. The device of claim 1, wherein the plurality of sets of the circumferentially spaced apart roller members provide a concave zone of contact between roller assembly and the external surface of the body.

7. The device of claim 1, wherein the roller members of the adjacent sets are staggered relative to each other.

8. The device of claim 1, wherein rotation of one or more of the wheels about the primary axis of rotation is driven by a drive motor.

9. The device of claim 1, wherein rotation of each one of the roller members relative to the wheel about its respective secondary axis of rotation is passive.

10. The device of claim 1, wherein the roller assemblies are mounted to the frame such that the primary axis of rotation is parallel to a tangent of the spherically shaped external surface of the body.

11. The device of claim 1, wherein the roller assembly is substantially biconcave in longitudinal section.

12. The device of claim 1, wherein the device includes three of the roller assemblies mounted to the frame in a circle at 120 degree intervals.

13. The device of claim 1, wherein the device includes four of the roller assemblies mounted to the frame in a circle at 90 degree intervals.

14. The device of claim 1, wherein at least a portion of the external surface of the rounded body for engagement with the roller members is the shape of a segment of a sphere.

15. The device of claim 1, including a user control input for a user to select a movement of the rounded body in any one or a combination of the pitch direction, the yaw direction and the roll direction and a control system for determining a selection of the one or more roller assemblies to be driven to drive the selected movement of the rounded body.

16. The device of claim 1, wherein the motion device is a motion platform for a flight simulator apparatus.

17. The device of claim 1, wherein the rounded body contains a simulated aircraft cockpit.

18. (canceled)

19. (canceled)

20. (canceled)

21. (canceled)

22. (canceled)

23. A roller assembly adapted to be mounted to a frame and for contacting an external surface of an at least partially rounded body to allow movement of the body in a pitch direction, a yaw direction and a roll direction relative to the frame, the roller assembly including:
a wheel rotatably mounted to the frame so as to rotate about a primary axis of rotation; and
a plurality of sets of circumferentially spaced apart roller members mounted to the wheel and radially spaced apart from the primary axis of rotation, each one of the roller members rotates with the wheel about the primary axis of rotation and rotates relative to the wheel about a respective secondary axis of rotation that is transverse to the primary axis of rotation, wherein in each set the roller members lie in a plane and are the same radial distance apart from the primary axis of rotation, and wherein the planes of adjacent sets are parallel and the roller members of one set are a different radial distance apart from the primary axis of rotation than the roller members of an adjacent set;
wherein at least part of the external surface of the body has a spherical shape with a constant radius from a central point, wherein the spherically shaped external surface contacts with at least one of the roller members and is thereby rotatable in any direction about the central point.

24. The roller assembly of claim 23, wherein the wheel includes a plurality of sets of the circumferentially spaced apart roller members, in each individual set the roller members lie in a plane and are the same radial distance apart from the primary axis of rotation, and the roller members of adjacent sets lie in parallel planes and are different radial distances apart from the primary axis of rotation.

25. The roller assembly of claim 17, wherein the difference between the radial distance apart from the primary axis of rotation of the roller members of adjacent sets complements the curvature of the spherical shaped external surface of the body.

26. The roller assembly of claim 17, wherein the plurality of sets of the circumferentially spaced apart roller members provide a concave zone of contact between roller assembly and the external surface of the body.

27. The roller assembly of claim 17, wherein the roller assembly is substantially biconcave in longitudinal section.
